(19) United States
(12) Patent Application Publication
(10) Pub. No.: US 2025/0038453 A1
(43) Pub. Date: Jan. 30, 2025

(54) Module element for plug-in connectors

(71) Applicant: HARTING Electric Stiftung & Co. KG, Espelkamp (DE)

(72) Inventors: Andreas RÜTER, Espelkamp (DE); Heiko MEIER, Espelkamp (DE); Christof HERMONI, Espelkamp (DE)

(73) Assignee: HARTING Electric Stiftung & Co. KG, Espelkamp (DE)

(21) Appl. No.: 18/713,817

(22) PCT Filed: Jan. 6, 2023
(86) PCT No.: PCT/DE2023/100006

§ 371 Date: May 28, 2024

(30) Foreign Application Priority Data
Jan. 24, 2022 (DE) 10 2022 101 535.1

(51) Int. Cl. H01R 13/518; H01R 13/514

(52) U.S. Cl. CPC H01R 13/518; H01R 13/514

(57) ABSTRACT

A modular element for assembly with a further modular element to form a plug-in connector module is suitable for arrangement in an accurately oriented manner at a plug-in location of the plug-in connector module. The plug-in location has a coding of the arrangement of the plug-in connector module in a first direction and a plug-in direction of the modular element; and the modular element has a coding which corresponds to the coding of the plug-in location. The modular element has a further coding which corresponds to the coding of the modular element in such a way that it is ensured that an assembled plug-in connector module, which is unsuitable for the plug-in location, without the coding and a correspondingly faulty attempt when assembling two modular elements are precluded.

### CROSS-REFERENCE TO RELATED APPLICATION

This application is a national stage application, filed under 35 U.S.C. § 371, of International Patent Application PCT/DE2023/100006, filed on Jan. 6, 2023, which claims the benefit of German Patent Application DE 10 2022 101 535.1, filed on Jan. 24, 2022.

### BACKGROUND

The disclosure relates to a plug-in connector module for a modular plug-in connector and in particular to a module element provided for supplying such a plug-in connector module. The disclosure moreover relates in particular to a construction kit for a modular plug-in connector.

Such plug-in connector modules are required to construct modular plug-in connectors. The plug-in connector modules here house modular contact inserts and a plurality of plug-in connector modules having contact inserts of the same or different type are combined to form a plug-in connector. The plug-in connector can thus be assembled and configured with a high degree of flexibility.

Plug-in connector modules are here either inserted directly into a plug-in connector housing or inserted and fixed first in a retaining frame. The retaining frame is then fitted in the plug-in connector housing with the plug-in connector modules accommodated therein.

A large number of plug-in connector modules for modular plug-in connectors are known from the prior art. They vary in size, the number of contact inserts, the contact means accommodated, the dimensioning of the contact inserts, and the type of the contact means. Depending on the configuration of the plug-in connector module, they can be used for the transmission of, for example, signals and currents of a digital, analog, electrical, pneumatic, mechanical, optical, or hydraulic type.

WO 2020/001688 A1 discloses a plug-in connector module for a modular plug-in connector which is composed of a first and second modular element. The plug-in connector module composed of two module elements is intended to enable an increased flexible combinability of contact inserts and/or variability of the contact inserts of the plug-in connector modules such that the plug-in connector can be configured for as large a number as possible of applications. In the case of the assembled plug-in connector module, in each case retaining contours at the two module elements interact in a form-fitting fashion. For desired fixing of the assembled module elements, a fixing element is moreover required which interacts with the two module elements in a form-fitting fashion. For orientation-faithful insertion of the plug-in connector module into a retaining frame of a plug-in connector, in each case a first and second module coding is provided at the first and second module element.

The retaining contour is disadvantageously designed in such a way that a first module element can be assembled with a first or second module element and a second module element with a first or second module element such that, because of the coding of the module elements, errors are disadvantageously possible during the fitting. With the fixing element, an additional element is moreover disadvantageously necessary for a completely assembled plug-in connector module.

The German Patent and Trademark Office has conducted a search and found the following prior art in the priority application to the present application: DE 10 2017 123 331 B3 and WO 2020/001688 A1.

### SUMMARY

Disclosed is a plug-in connector module for a modular plug-in connector which enables flexible and variable combinability of contact inserts and in particular to supply a module element suitable for the plug-in connector module. It is intended here that the combinability of the contact inserts and the fitting of the plug-in connector module and the plug-in connector are possible in a flexible and simple fashion. Further disclosed is a construction kit for such a plug-in connector.

The disclosure relates in particular to a module element for assembly to a further module element to form a plug-in connector module which is suitable for orientation-faithful arrangement at a plug-in location of the plug-in connector module. For example, the plug-in location can be supplied in a retaining frame of a plug-in connector.

For this purpose, the plug-in location has a coding for arrangement of the plug-in connector module in a first direction and a plug-in direction of the module element, and the module has a corresponding coding which corresponds to the coding of the plug-in location.

The module element has a further (element) coding in addition to its module coding corresponding to the coding of the plug-in location. The further coding is particularly advantageously designed and arranged so that it corresponds to the coding of the module element in such a way that it is ensured that an assembled plug-in connector module which is unsuitable for the plug-in location, without its coding corresponding to the coding of the plug-in location and for its proper abovementioned orientation-faithful arrangement, as well as a correspondingly incorrect attempt when assembling two module elements, are largely excluded. In this way, it is moreover advantageously ensured here that incorrect placement at a plug-in location, for example of a retaining frame of a plug-in connector, is likewise largely excluded.

The module element is designed to supply the abovementioned advantageous effect in a suitable fashion in such a way that the assembled plug-in connector module has a first and a second module coding for the orientation-faithful arrangement of the plug-in connector module at the plug-in location, in particular in the first direction. It is clear that the coding of the plug-in location here likewise has a first and second coding accordingly designed in a corresponding fashion.

A module element can be supplied in a suitable fashion by a first module element which has the first coding, whereas a further module element can be supplied by a second module element which has the second coding.

The first module element having the first coding can, in addition to its first coding, in a suitable fashion have a third coding, and the second module element having the second coding can, in addition to its second coding, in a suitable fashion have a fourth coding.

The third and fourth coding are here designed, in order to enable the abovementioned advantageous effect, as corresponding to each other in such a way that the first module element and the matching second module element can be assembled properly correctly in the first direction to form the plug-in connector module with the first and second coding, whilst two first module elements cannot be assembled with their same first and third codings or two second module elements with their same second and fourth codings.

The first coding is arranged and designed in a suitable fashion on a first wall of the first module element, wherein the third coding can advantageously be arranged and designed at at least one edge of a second wall, situated opposite the abovementioned first wall in the first direction, of the first module element.

In a similar fashion to the abovementioned arrangement and design of the first and third coding of the first module element, the second coding is arranged and designed in a suitable fashion on a first wall of the second module element, wherein the fourth coding can advantageously be arranged and designed at at least one edge of a second wall, situated opposite the abovementioned first wall in the first direction, of the second module element.

The first and second coding provided in each case at the first wall of the first and second module element can be designed in a suitable fashion as opposite lugs which extend in the first direction and have different dimensions in a second direction. The lugs are here arranged in a suitable fashion on a level, counter to the plug-in direction, adjacent to an upper rim of the first and second module element in each case in the plug-in direction.

The module elements have in a suitable fashion in each case one retaining contour at their second walls which are designed as corresponding and interact in such a way that the first and second module element assembled in the first direction form the plug-in connector module with the first and second coding, wherein the second walls are arranged adjacent to each other and their retaining contours engage in each other.

As with the abovedescribed third and fourth coding, the retaining contours are advantageously in each case formed at edges, extending in the plug-in direction of the first and second module element, of the second wall, according to which a structural space for contact inserts and contact means in the first and second module element is not adversely affected.

The retaining contours can here be supplied in a suitable fashion by means of tabs extending in the first direction and in the plug-in direction and pockets, designed to correspond with the tabs, which are arranged adjacently and in succession in a row such that the retaining contours are designed particularly compactly in particular in the plug-in direction. Alternatively, a tab can also in each case be arranged on a tab or a pocket on a pocket, adjacent to one another in succession in a row, wherein more space is required for a retaining contour designed in such a way in the plug-in direction.

The tabs can here be formed as narrow projections and the pockets as correspondingly narrow recesses or steps which extend in particular in each case in the plug-in direction at the edges of the second walls and extend in the first direction in which the first and second module element are assembled to form a plug-in connector module.

The retaining contours are here designed and arranged in such a way that the retaining contour of the first module element and the retaining contour of the second module element of a plug-in connector module assembled from the first and second module element engage inside each other in such a way that the second walls of the first and second module element are, as described above, arranged adjacently opposite each other and touch each other.

The retaining contours can here advantageously moreover be designed in such a way that the tabs of the first and second module element are inserted, in the first direction and the second direction and in the plug-in direction, in form-fitting fashion in each case into the pockets of the second or first module element in such a way that the first and second module element are held against each other in the first direction, the second direction, and the plug-in direction so that they cannot twist or tilt and are moreover held in the second direction and the plug-in direction so that they cannot be displaced.

The tabs can particularly advantageously have a predetermined oversize compared with the pockets such that the tabs of the first and second module element can each be inserted in the first direction in a form-and force-fitting fashion into the pockets of the second or first module element in such a way that the first and second module element are arranged in the first direction, the second direction, and the plug-in direction so that they cannot twist, tilt, or be displaced, wherein the tabs inserted into the pockets are plastically deformed in particular in the first direction.

In order to supply their abovementioned property, the tabs can have at least one rib which widens the tabs in and/or counter to the plug-in direction and extends in the first direction. It is clear that a rib is in a suitable fashion formed as a single piece with a tab and the first and the second module element are here supplied from a plastic with a predetermined suitable ductility. The material is here advantageously selected such that the advantageous plastic deformation is not substantially adversely affected when the first and the second module element are repeatedly assembled and disassembled.

The tabs can moreover have bevels, in the form of chamfered or rounded edges in particular at their rim extending in the plug-in direction, which facilitate insertion of the tabs into the pockets when the first and the second module element are assembled.

The pockets which interact with the tabs in form-fitting fashion and in a suitable fashion also in force-fitting fashion can have bevels, in the form of chamfered or rounded edges at their rim, which in particular interact with the bevels and rounded edges of the tabs and thus facilitate insertion of the tabs into the pockets when the first and the second module element are assembled.

The first and the second module element can be produced from a suitable plastic and in particular from fiberglass-reinforced polycarbonate by means of injection molding. The two module elements of an assembled plug-type connector module can additionally, for example, be adhesively bonded to each other or be connected by means of ultrasonic or laser welding.

Modified configurations of the first and the second module element with correspondingly modified tabs can in particular, because the module elements do not have spring elements, also be supplied from metal or ceramic, wherein the module elements of an assembled plug-in connector module are held in the second direction and plug-in direction so that they cannot be displaced, tilt, and twist and are held against each other in the first direction so that they cannot tilt and twist. After insertion of the plug-in connector module into a retaining frame, the module elements are held against each other by the retaining frame in the first direction additionally so that they cannot be displaced.

A groove, which surrounds a depression, designed as a large area and provided in a predetermined central region of the second wall, can be formed on the second wall of at least one of the module elements. In order to supply a plug-in connector module assembled particularly reliably from the first and the second module element, in particular the central region, having the large-area depression, of the second wall can additionally be adhesively bonded to the second wall arranged adjacently opposite it, using a double-sided adhesive pad or adhesive strip or liquid adhesive, in addition to the retaining contours. The groove is here in a suitable fashion designed and arranged in such a way that it can advantageously receive excess adhesive.

The provision of the central depression with the groove surrounding it at just one of the module elements and, for example, at the first module element allows simple identification of this first module element and hence a simple means of distinguishing between the first and the second module element. By means of provision of the central depression with the groove surrounding it at all the first module elements and at none of the second module elements, advantageous marking can accordingly moreover be supplied for simple and unambiguous distinguishing between the first and the second module element, which favors simple, error-free, and safe assembly and fitting of the plug-in connector module.

In order to supply a plug-in connector module assembled particularly reliably from the first and the second module element, in each case two tabs and pockets can advantageously be arranged in the plug-in direction above and below an application point of the assembled plug-in connector module on a level with the first and second coding of the plug-in connector module such that torques initiated by plug-in and pulling forces and acting on a separation point of the assembled module elements are largely canceled out.

The tabs can moreover in a suitable fashion have in the plug-in direction a predetermined length which is selected in such a way that plug-in and pulling forces acting in the plug-in direction can be absorbed by the tabs.

The module elements can be designed in such a way that the assembled plug-in connector module has in each case a length of 1 to 4 cm in the first and second direction. The length of a module element in the first direction is here preferably approximately 1.5 cm and in the second direction approximately 1.6 cm. The tabs and pockets can here in a suitable fashion in the plug-in direction in each case have a length of approximately 3 mm and also extend by approximately 2 mm in the first direction. The thickness, extending in the second direction, of the tabs is advantageously approximately 1 mm. The retaining contour supplied with the tabs and pockets can accordingly be designed with the abovementioned advantageously small dimensions but nevertheless obtain a desirably high mechanical strength.

A particularly advantageous retaining contour can have in each case two tabs and two pockets at the edges of the second walls, wherein in each case a first tab, a first pocket, a second tab, and a second pocket and moreover in each case a first pocket, a first tab, a second pocket, and a second tab can be provided in this order at an edge of a second wall of the first and the second module element.

With the abovementioned particularly advantageous retaining contours, the third and fourth coding are in a suitable fashion moreover in each case integrated into the retaining contour of the first and the second module element, according to which the retaining contour has an advantageous dual function. Such an advantageous configuration is described in detail below with reference to the drawings FIGS. 2, 3, 4A and B.

A further retaining contour with a third and fourth coding integrated in a different fashion can be supplied by means of a projection arranged on a tab and a recess provided in a pocket, which are accordingly designed and arranged in a corresponding fashion.

Unlike the abovedescribed configurations, the third and fourth coding can in each case be designed in a suitable fashion at at least two opposite edges of the second wall of the first and the second module element. The third and fourth coding can here be arranged in each case at an edge adjacent to a retaining contour preferably following the retaining contour in the plug-in direction. The third and fourth coding can here have projections and recesses or steps which are suitably designed so that they correspond with one another and which moreover can be provided at the edges extending in the second direction, wherein corresponding configurations are described in detail below with reference to the drawings FIGS. 5 and 6, 7 and 8.

An abovedescribed module element can be designed as differing in many fashions, in particular also in terms of the type and number of its contact inserts and contact means, and can also have high-density contact inserts and contact means. By virtue of the design of the tabs and pockets with a small space requirement, optimized interaction both with electrical and optical contacts and with pneumatic contacts can be achieved.

An abovedescribed first module element can in a suitable fashion be suitably designed with a predetermined first number of contact inserts in each case for receiving a pin-like contact means, or be designed as a first module element with a predetermined second number of contact inserts in each case for receiving a socket-like contact means.

Similarly, a second module element can also in a suitable fashion be suitably designed with a predetermined third number of contact inserts in each case for receiving a pin-like contact means, or be designed as a second module element with a predetermined fourth number of contact inserts in each case for receiving a socket-like contact means. It is clear that the abovementioned first, second, third, and fourth number can in each case be the same or different.

The contact inserts of the first and the second module element can particularly advantageously be clearly identified with labels of a second, third, fourth, or fifth marking, wherein each individual contact insert of an individual module element is clearly identified and can be provided, for example, with suitable numbering. In this way, the contact inserts can also be correctly equipped with predetermined contact means. The contact inserts can here in a suitable fashion moreover be clearly identified as contact inserts of a first or second module element.

Correct assembly of a predetermined plug-in connector module having a first and second module element is also simplified and facilitated by the abovedescribed marking and incorrect assembly of the plug-in connector module avoided.

The disclosure accordingly moreover relates to a construction kit with a large number of differently designed first and second module elements which, as described above, are advantageously provided in each case with clear markings and labels. The construction kit is particularly suitable for the simple, correct, and error-free assembly of a predetermined plug-in connector module from a first and second module element selected correspondingly from the large number of module elements.

An abovementioned construction kit is here particularly suitable for the placement of a large number of different plug-in connector modules at a retaining frame of a modular plug-in connector, wherein the retaining frame has a large number of plug-in locations, clearly identified with labels of a first marking, for the plug-in connector modules. The labels of the second, third, fourth, and fifth marking are here selected in the construction kit in a suitable fashion in such a way that they differ from the labels of the first marking such that the plug-in connector modules can be assigned in a simple fashion clearly to a predetermined plug-in location.

The plug-in connector module and in particular the first and the second module element have been described above with reference to the in each case mentioned first direction, second direction, and the plug-in direction. With reference to the plug-in direction, within the overall context of the application a defined direction is here established as meaning that also a direction counter to the plug-in direction is referred to.

Within the overall context of the application, in this respect the first direction is used differently from the plug-in direction. The first direction is here namely also used for a direction in the opposite direction to the first direction. As an example, it should be mentioned here that the two lugs of the plug-in connector module are described as lugs extending in the first direction. For the sake of clarity and simplicity, this is described as such in the application, the two lugs of course actually being in each case oriented in precisely opposite directions in the first direction.

### BRIEF DESCRIPTION OF THE DRAWINGS

Exemplary embodiments of the invention are illustrated in the drawings and are explained in detail below.

FIG. 1A shows a retaining frame suitable for a plug-in connector module;

FIG. 1B shows a schematic illustration of a plug-in connector module, assembled from two module elements;

FIG. 2 shows the module elements of FIG. 1B in enlarged perspective illustrations;

FIG. 3 shows further perspective illustrations of the module elements of FIG. 2;

FIG. 4A shows the assembled module elements of FIGS. 2 and 3;

FIG. 4B shows module elements of FIGS. 2 and 3, arranged adjacent to each other;

FIG. 5 shows in a perspective illustration two further module elements;

FIG. 6 shows the module elements of FIG. 5 from a different perspective and a plug-in connector module assembled from the module elements;

FIG. 7 shows in a perspective illustration two further module elements;

FIG. 8 shows the module elements of FIG. 7 from a different perspective and a plug-in connector module assembled from the module elements;

FIG. 9 shows in a perspective illustration two further module elements;

FIG. 10 shows the module elements of FIG. 9 from a different perspective and a plug-in connector module assembled from the module elements;

FIG. 11A shows examples of plug-in connector modules assembled from two module elements; and

FIG. 11B shows two plug-in connector modules of FIG. 11A in an enlarged illustration.

### DETAILED DESCRIPTION

The figures contain partially simplified schematic illustrations. Identical reference signs are in part used for the same but possibly non-identical elements. Not all the reference signs are entered in all the drawings. Different views of the same elements could be to a different scale.

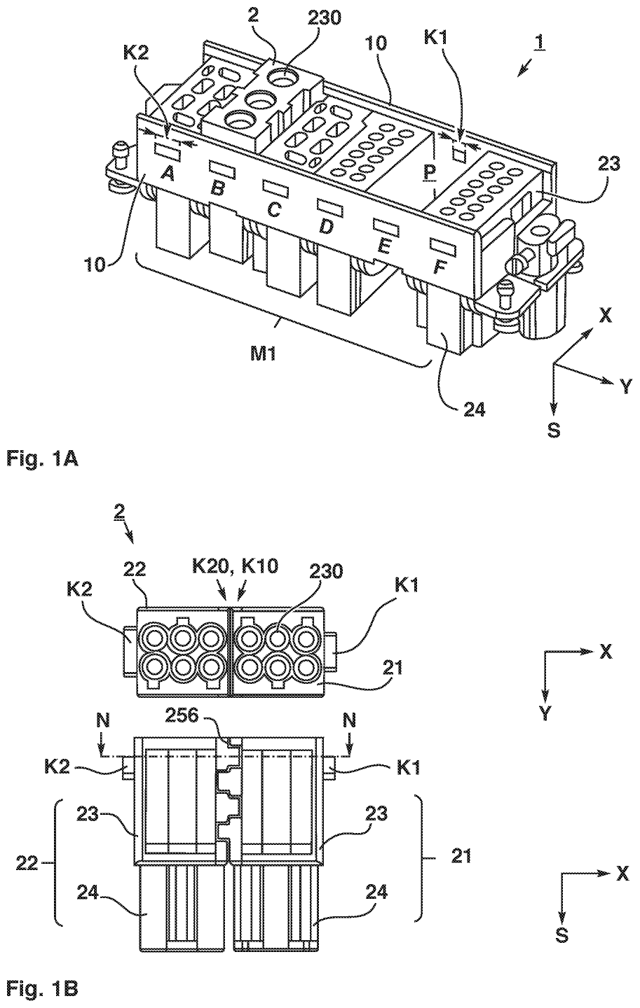

FIG. 1A shows a retaining frame 1, suitable for a plug-in connector module 2, which is suitable for use in a plug-in connector housing of a modular plug-in connector. The retaining frame 1 is a hinged frame with two side walls 10, situated opposite each other, which extend in a second direction Y parallel to each other. For a proper fit of the plug-in connector modules 2 in the retaining frame, the walls 10 in each case have retaining contours which interact in a form-fitting fashion with retaining contours, provided on the plug-in connector modules 2, of the plug-in connector modules 2. For correctly oriented proper insertion of a plug-in connector module 2 in a first direction X into the retaining frame 1, the abovementioned retaining contours of the retaining frame 1 and the plug-in connector modules 2 each have correspondingly designed module codings K1, K2.

The retaining contours of the retaining frame 1 are in each case first and second recesses, situated opposite each other, in the first and second wall 10, the dimension and/or contour of which differ, for example, in each case in the second direction Y. The retaining contours of a plug-in connector module 2 suitable for the retaining frame 1 are correspondingly a first and second lug which are provided on walls, situated opposite each other in the first direction X, of the plug-in connector module 2 and which in each case correspond in form-fitting fashion with a first and second recess of the retaining frame 1. The first and second recesses of the retaining frame 1 and the first and second lugs of the plug-in connector module 2 here have a first K1 and second K2 module coding which specifies correctly oriented proper insertion of the plug-in connector module 2 in the first direction X.

The retaining frame 1 is designed to accommodate six plug-in connector modules 2 arranged next to one another and in succession in the second direction Y of the retaining frame 1, wherein the plug-in connector modules 2 can each have contact inserts 230 for different contact means, and wherein the plug-in connector modules 2 can furthermore in particular also have functional elements such as, for example, a sensor system for detecting an operating state, for example, of a plug-in connector module 2. In the drawings, five plug-in connector modules 2 are inserted into the retaining frame 1 and a plug-in location P for a further plug-in connector module 2 is unoccupied.

The plug-in connector modules 2 properly inserted into their plug-in location P here extend with their cable connection regions 23 and their plug-in regions 24, as well as with their contact inserts 230 provided for accommodating contact means, in a third direction S, namely the plug-in direction S of the plug-in connector modules 2.

For correct insertion, moreover in the second direction Y, of a plug-in connector module 2 into the retaining frame 1, labels of a first marking M1, namely A, B, C, D, E, and F for labeling its six plug-in locations P, are provided in a suitable fashion on the retaining frame 1. The first marking M1 is in particular helpful for correct assignment of a plug-in connector module 2 to a plug-in location P during the placement of plug-in connector modules 2 at the retaining frame 1, which retaining frame can be provided for interaction with a correspondingly designed retaining frame of a mating plug-in connector. The retaining frame, designed so that it corresponds with the retaining frame 1, of the mating plug-in connector can, for correct assignment of a plug-in connector module 2, in a suitable fashion also have labels of a first marking M1, namely a, b, c, d, e, and f, which advantageously correspond with the labels of the marking M1 of the retaining frame 1 and label the retaining frame moreover as the retaining frame of the mating plug-in connector. It is clear that the first, second, and third direction X, Y, and S are each arranged perpendicularly to one another.

FIG. 1B shows a schematic illustration of a plug-in connector module 2 assembled from a first 21 and a second 22 module element in each case in a plan view in the plug-in direction S and in the second direction Y. The two walls, situated laterally opposite each other in the first direction X, of the plug-in connector module 2 have in each case a first and second lug with an abovedescribed first K1 and second K2 module coding.

The plug-in connector module 2 is accordingly suitable for a retaining frame 1 according to FIG. 1A. The first K1 and second K2 module coding of the plug-in connector module 2 corresponds in each case with the first K1 and second K2 module coding of the retaining frame 1, according to which, as described above, orientation-faithful arrangement of the plug-in connector module 2 in the first direction X in the retaining frame 1 is predetermined and ensured.

The first K1 and second K2 module coding is provided in each case on a wall of the first 21 and second 22 module element, wherein their walls, in each case situated opposite each other, are arranged adjacently to each other and touch each other in the assembled plug-in connector module 2. In each case a first and a second retaining contour 256, which interact in a form-fitting and force-fitting fashion, are formed on the edges, extending in the plug-in direction S, of the abovementioned walls, arranged adjacently to each other, of the first 21 and second 22 module element. The module elements 21 and 22 are here assembled in the first direction X to form the plug-in connector module 2 in such a way that they are arranged in the first X, second Y, and third direction S in each case so that they cannot twist, tilt, and be displaced relative to each other.

The module elements 21 and 22 each have a cable connection region 23 and a plug-in region 24 which extend in succession in the plug-in direction S. The first K1 and second K2 module coding and the first and second retaining contour 256 are each formed on the cable connection region 23 of the first 21 and second 22 module element, which cable connection region moreover has contact inserts 230 suitable for contact means. The module elements 21 and 22 have, for example, in each case six contact inserts 230, wherein the module elements 21 and 22 can be designed in correspondingly different versions with their contact inserts 230 in each case for receiving contact means designed in the manner of sockets or pins.

The lugs provided on the cable connection region 23 are provided with their coding K1 and K2 in a suitable fashion on a level N spaced apart from the plug-in region 24 counter to the plug-in direction S, adjacent to an upper rim of the cable connection region 23 such that secure retention of the assembled plug-in connector module 2 in the retaining frame 1 and a compact construction of a fully occupied retaining frame 1 is supplied.

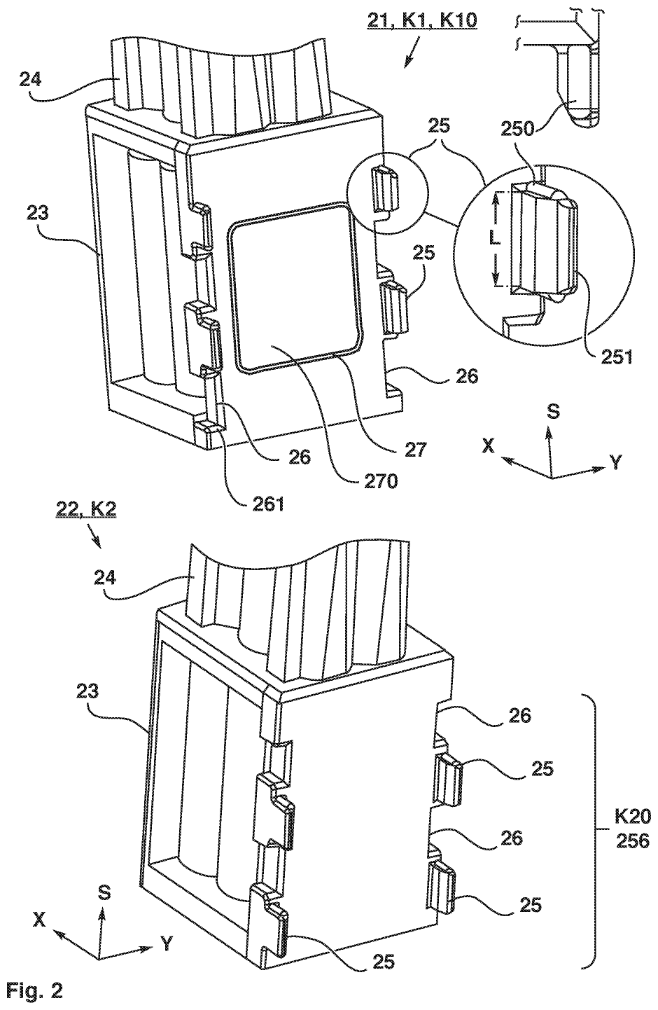

The module elements 21 and 22 of the plug-in connector module 2 are described, in particular with their cable connection regions 23 and their retaining contours 256, in detail below with reference to FIGS. 2, 3, and 4A and B.

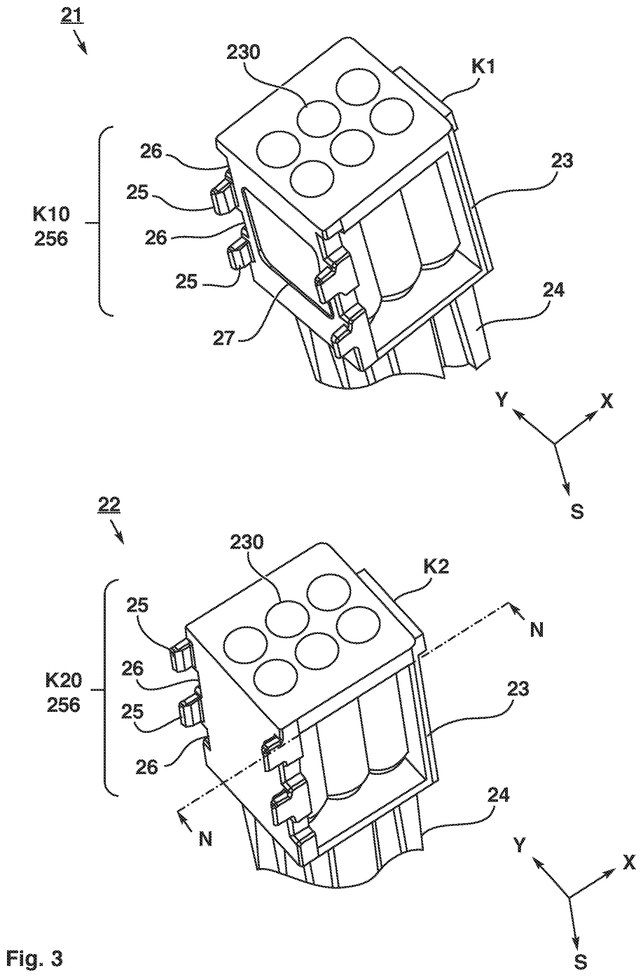

FIGS. 2 and 3 show the module elements 21 and 22 of FIG. 1B in enlarged perspective illustrations with a view in particular of their retaining contours 256 which are formed in each case at two edges, extending in the plug-in direction S, of a wall of the module elements 21 and 22.

The retaining contours 256 of the module elements 21 and 22 are designed and arranged so that they correspond with one another in such a way that the first 21 and second 22 module element can be assembled in the first direction X to form an abovedescribed plug-in connector module 2. The retaining contours 256 of the module elements 21 and 22 here engage, as described above, in one another in a form- and force-fitting fashion.

The retaining contours 256 are advantageously provided at the edges of a wall of the module elements 21 and 22 such that a desirably large structural space for contact inserts 230 and contact means in the cable connection region 23 is made available.

The retaining contours 256 here have in each case tabs 25 and pockets 26 extending in the first direction X and which are arranged alternately in succession relative to each other in the plug-in direction S. The tabs 25 are designed and arranged so that they correspond with the pockets 26 in such a way that a tab 25 inserted into a pocket 26 is arranged and retained in the pocket 26 in a form-and force-fitting fashion.

For this purpose, the tabs 25 extending in the direction X and in the plug-in direction S and designed as projections have a predetermined oversize, compared with the pockets 26 designed as recesses or steps, which is designed and arranged in such a way that the tabs 25 are plastically deformed when they are inserted into the pockets 26. For this purpose, the tabs 25 have a predetermined length L in the plug-in direction S and in a suitable fashion in particular at least one rib 250 widening the tabs 25 in each case in and/or counter to the plug-in direction S and extending in the direction X.

The length L of the tabs 25 is here selected in a suitable fashion in such a way, and the rib 250 designed in such a way, that in particular the rib 250 is plastically deformed when the tabs 25 are inserted into the pockets 26. Moreover, bevels 251 in the form of chamfered or rounded edges are provided at the tabs 25, and bevels 261 in the form of chamfered or rounded edges are provided at the pockets 26, which in each case favor simple insertion of the tabs 25 into the pockets 26. In each case two ribs 250, which are designed in the plug-in direction S at edges, extending in the direction X, of the tabs 25 are provided in a suitable fashion at a tab 25.

The predetermined length L of the tabs in the plug-in direction S is in a suitable fashion selected in such a way that plug-in and pulling forces occurring when a plug-in connection is supplied and released and acting on the module elements 21 and 22 can be completely absorbed.

A form fit of the retaining contours 256 of the assembled module elements 21 and 22 in the second direction Y and in the plug-in direction S is supplied by means of the abovedescribed tabs 25 and pockets 26. An additional force fit in the first direction X is furthermore obtained by the tabs 25 provided with ribs 250. In this way, the module elements 21 and 22 assembled to form a plug-in connector module 2 are advantageously retained so that they cannot twist, tilt, and be displaced in all directions X, Y, and S.

The tabs 25 and pockets 26 are advantageously arranged in the plug-in direction S above and below an application point of lever forces occurring when a plug-in connection of the assembled plug-in connector module 2 is supplied and released such that torques acting on the module elements 21 and 22 are compensated. In this way, the risk of unintentional separation of the assembled module elements 21 and 22 is advantageously minimized.

The walls of the module elements 21 and 22, on the edges, directed in the plug-in direction S, of which the retaining contours 256 are provided, can moreover be adhesively bonded to each other when the module elements 21 and 22 are assembled to form the plug-in connector module 2 using a double-sided adhesive pad or adhesive strip, or a liquid adhesive, such that a particularly stable assembled plug-in connector module 2 is supplied. For this purpose, a groove 27, which surrounds a depression 270, designed as a large area and provided in a predetermined central region 270 of the second wall, is formed in a suitable fashion at the wall of the first module element 21. The groove 27 here serves to receive excess adhesive applied to the central depressed region 270. The provision of the depression 270 with the groove 27 surrounding it only on the first module element 21 moreover makes it easier to distinguish between the module elements 21 and 22 and hence to handle them during fitting.

In the case of the retaining contours 256 of the second module element 22, in each case a first tab 25, a first pocket 26, a second tab 25, and a second pocket 26 are provided in this order in succession in the plug-in direction S at the edges of the wall situated opposite the coding K2 of the module element 22. In the case of the retaining contours 256 of the first module element 21, in each case a first pocket 26, a first tab 25, a second pocket 26, and a second tab 25 are arranged in this order in succession in the plug-in direction S at the edges of the wall situated opposite the coding K1 of the first module element 21.

By means of the abovedescribed arrangement of the retaining contour 256 of the first module element 21, an advantageous third coding K10 of the first module element is supplied which is arranged and designed in such a way that a first module element 21 cannot be assembled with a further first module element 21 to form a plug-in connector module 2.

By means of the abovedescribed arrangement of the retaining contour 256 of the second module element 22, an advantageous fourth coding K20 of the second module element 22 is moreover supplied which is arranged and designed in such a way that a second module element 22 cannot be assembled with a further second module element 22 to form a plug-in connector module 2.

The third coding K10 of the first module element 21 is here advantageously arranged and designed so that it corresponds with the fourth coding K20 of the second module element 22 in such a way that the first module element 21 can be assembled in the first direction X with the second module element 22 to form a plug-in connector module 2.

Because the first module element 21 moreover has the abovedescribed coding K1 in addition to the coding K10, and the second module element 22 moreover has the abovedescribed coding K2 in addition to the coding K20, it is advantageously ensured with the coding K10 and K20 that an assembled plug-in connector module 2 wrongly having two same first module elements 21 or two same second module elements 22 is not possible.

The correspondingly designed codings K10 and K20 are advantageously supplied by means of the abovedescribed arrangement of the retaining contours 256 which here have an advantageous dual function because the coding K10 and K20 is in each case integrated into the corresponding retaining contour 256.

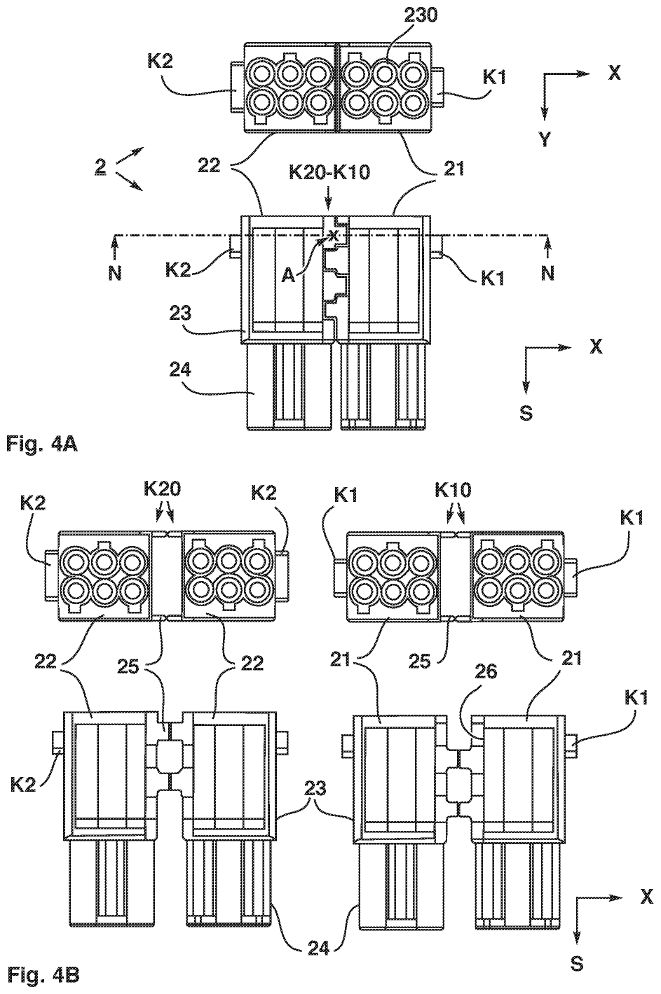

FIG. 4A shows the first 21 and second 22 module element of FIGS. 2 and 3, assembled in the direction X to form a proper plug-in connector module 2, wherein the retaining contours 256 of the first 21 and second 22 module element engage properly with their coding K10 and K20 in one another and interact correspondingly. The plug-in connector module 2 has the coding K1 and K2 and accordingly corresponds to a plug-in connector module 2 of FIG. 1B suitable for the retaining frame 1 of FIG. 1A, for which reason reference is made here to the above description with reference to the corresponding drawings.

As also described above, the tabs 25 and pockets 26 of the retaining contours 256 are arranged in the plug-in direction S above and below the application point A in a retaining frame 1 of lever forces occurring when a plug-in connection of the assembled plug-in connector module 2 is supplied or released such that torques acting on the module elements 21 and 22 are compensated. This applies in particular for the tabs 25 and pockets 26 situated at the level N of the lugs.

FIG. 4B shows further adjacently arranged module elements 21 and 22 of FIGS. 2 and 3, wherein two first module elements 21, because of their third coding K10, and two second module elements 22, because of their fourth coding K20, cannot be assembled to form a plug-in connector module 2.

Illustrated in the drawings are two first module elements 21 which are arranged adjacently to each other in the first direction X with their retaining contours 256 having in each case the coding K10. The tabs 25 of the retaining contours 256 in each case touch each other and the retaining contours 256 cannot interact so that they engage in one another in a form-and force-fitting fashion. Two first module elements 21 can accordingly not be assembled to form a plug-in connector module 2, according to which a plug-in connector module 2 wrongly having two codings K1 is advantageously excluded.

Two second module elements 22, which are arranged adjacently to each other in the first direction X with their retaining contours 256 having in each case the coding K20, are moreover illustrated in FIG. 4B. The tabs 25 of the retaining contours 256 touch each other in each case and the retaining contours 256 likewise cannot properly interact so that they engage in one another in a form-and force-fitting fashion. Two second module elements 21 can also accordingly not be assembled to form a plug-in connector module 2, according to which a plug-in connector module 2 wrongly having two codings K2 is likewise advantageously excluded.

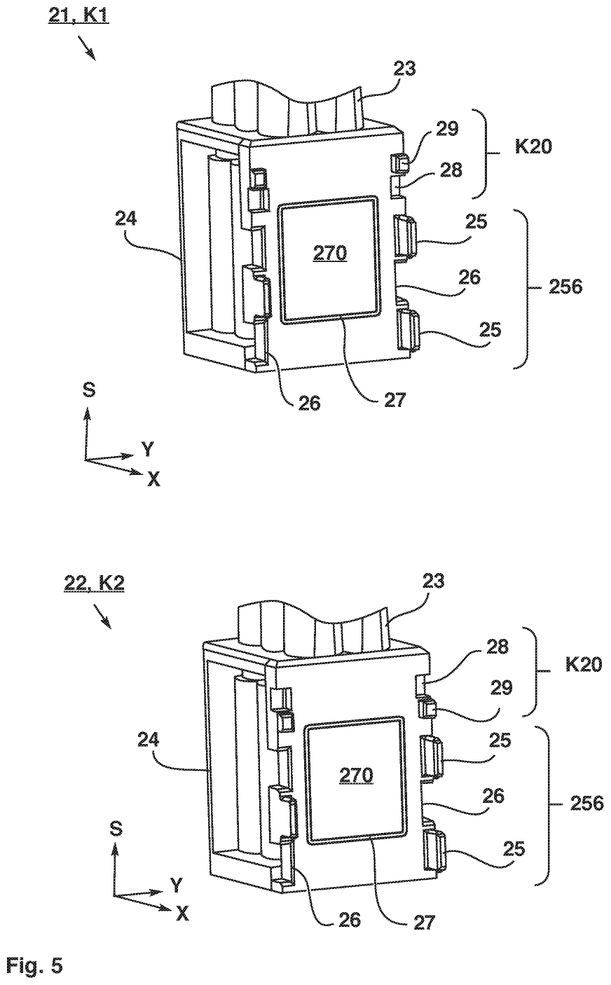

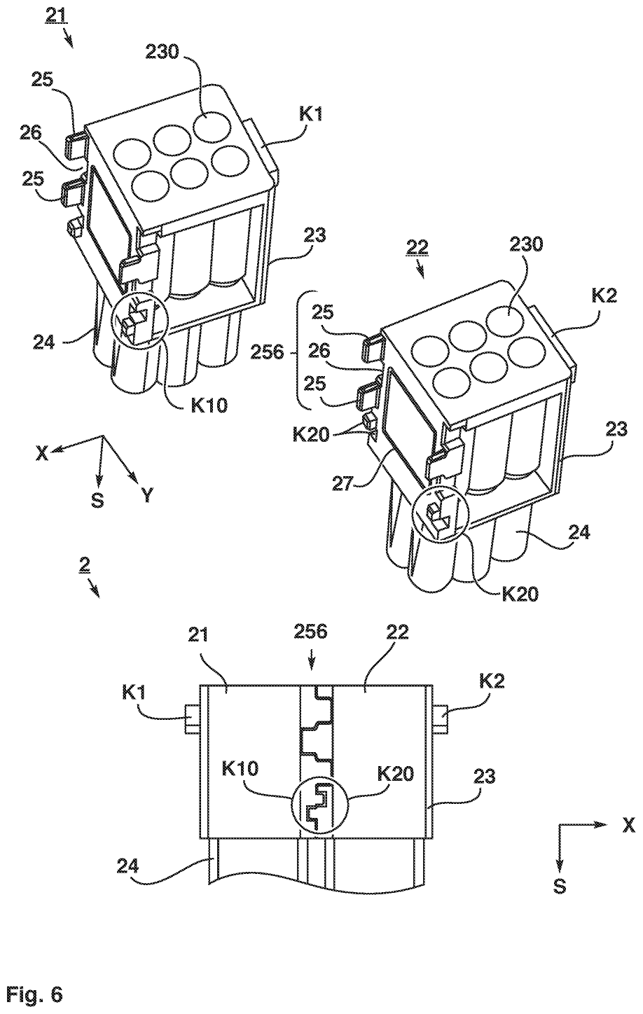

FIGS. 5 and 6 show in a perspective illustration two further module elements 21 and 22. The module elements 21 and 22 correspond, with their retaining contours 256 which are provided at edges, extending in the plug-in direction S, of a wall of the module elements 21 and 22, substantially to the configuration of FIG. 2, for which reason in this regard reference is made here to the above description. The central depression 270 is provided with the groove 27 surrounding it here, for example, on two module elements 21 and 22.

Unlike the configuration of FIG. 2, the retaining contour 256 has, at one edge of the module elements 21 and 22, in each case a tab 25, a pocket 26, and a further tab which are arranged in this order in succession adjacently in the plug-in direction S, and at the other edge in each case a pocket 26, a tab 25, and a further pocket 26 which are arranged in this order in succession adjacently in the plug-in direction S.

Unlike the configuration of FIG. 2, the coding K10 of the first module element 21 and the coding K20, corresponding to the coding K10, of the second module element 21 is thus not already supplied by the arrangement and design of the tabs 25 and the pockets 26 of the retaining contours 256.

The third and fourth coding K10 and K20 of the configuration of FIGS. 5 and 6 is likewise arranged at the corresponding edges of the module elements 21 and 22 in the plug-in direction S following the retaining contours 256.

The coding K10 of the first module element 21 here has in each case a recess 28 and a projection 29 which are arranged in the plug-in direction S in this order at the edges of the module element 21 following the retaining contours 256. The coding K20 of the second module element 22 has in each case a projection 29 and a recess 28 which are arranged in the plug-in direction S in this order at the edges of the module element 22 following the retaining contours 256.

The projections 29 extending in the first direction X are, compared with the tabs 25, designed as relatively compact studs 29 which, unlike the tabs 25, do not have ribs and bevels and which, unlike the tabs 25, do not interact in force-fitting fashion with the recesses 28.

The codings K10 and K20 are here designed so that they correspond with each other in such a way that, in the case of an assembled first 21 and second 22 module element, the projections 29 are arranged in the recesses 28 and an assembled plug-in connector module 2 is supplied, whereas a first module element 21 cannot be assembled with a further first module element 21, and a second module element 22 cannot be assembled with a further second module element 22. Illustrated in the drawings is a plug-in connector module 2 assembled from a first 21 and second 22 module element.

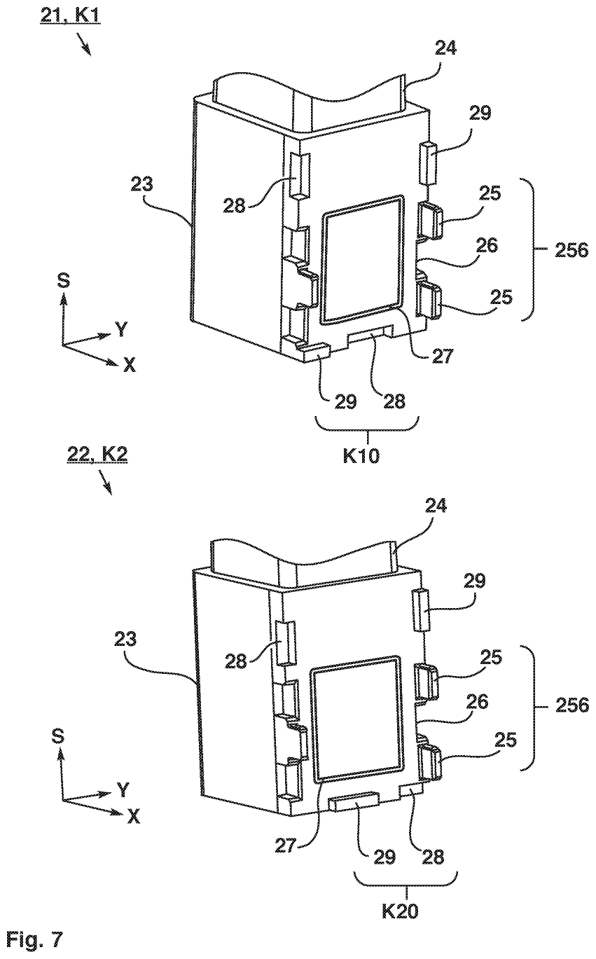

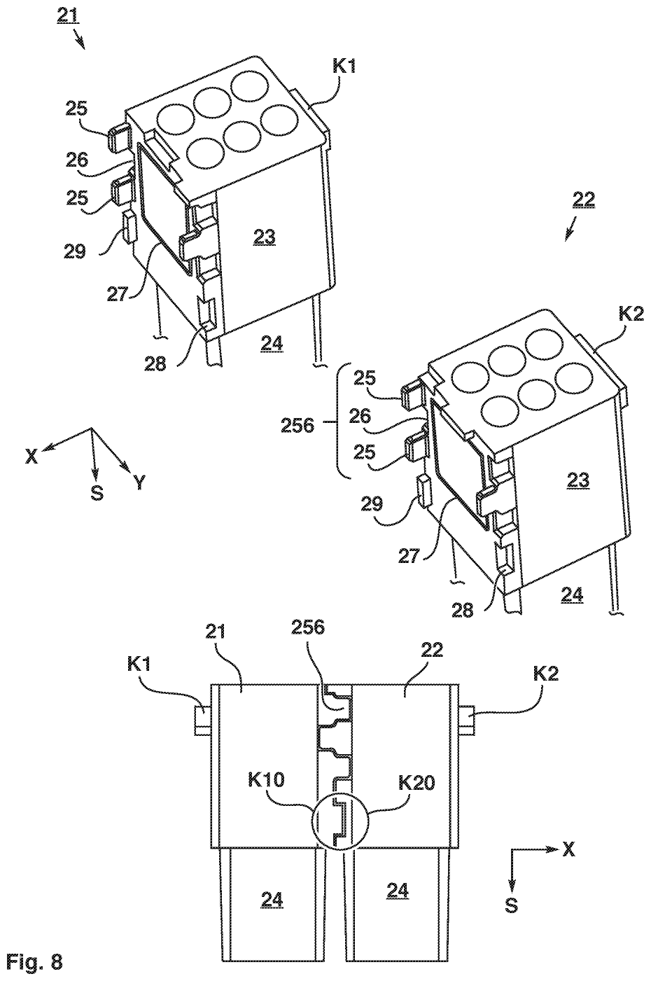

FIGS. 7 and 8 show in a perspective illustration two further module elements 21 and 22. The module elements 21 and 22 correspond, with their retaining contours 256 which are provided at edges, extending in the plug-in direction S, of a wall of the module elements 21 and 22, substantially to the configuration of FIG. 5, for which reason in this regard reference is made here to the above description.

Unlike the configuration of FIG. 5, the coding K10 and K20 of the configuration of FIGS. 7 and 8 is likewise arranged at the corresponding edges of the module elements 21 and 22 in the plug-in direction S following the retaining contours 256 and is moreover arranged at an edge transversely to the plug-in direction S which extends in the second direction Y.

The coding K10 of the first module element 21 has a recess 28 at one edge, extending in the plug-in direction S, of the module element 21 following the retaining contour 256 and has a projection 29 at the other edge extending in the plug-in direction S. The coding K10 of the first module element 21 moreover has a recess 28 and a projection 29 at an edge extending in the second direction Y.

The coding K20 of the second module element 22 likewise has a recess 28 at one edge, extending in the plug-in direction S, of the module element 22 following the retaining contour 256 and has a projection 29 at the other edge extending in the plug-in direction S. The coding K20 of the second module element 21 likewise moreover has a recess 28 and a projection 29 at an edge extending in the second direction Y.

The codings K10 and K20 are likewise designed so that they correspond with each other in such a way that, in the case of an assembled first 21 and second 22 module element, the projections 29 are arranged in the recesses 28 and an assembled plug-in connector module 2 is supplied, whilst a first module element 21 cannot be assembled with a further first module element 21, and a second module element 22 cannot be assembled with a further second module element 22. Illustrated in the drawings is a plug-in connector module 2 assembled from a first 21 and second 22 module element.

The projections 29 extending in the first direction X are likewise designed as relatively compact compared with the tabs 25 and differ from the stud-like projections 29 of the configuration of FIG. 5 in their relatively elongated design in the plug-in direction S and in the direction Y. The projections 29 here likewise do not have ribs and bevels and, unlike the tabs 25, do not interact in force-fitting fashion with the recesses 28.

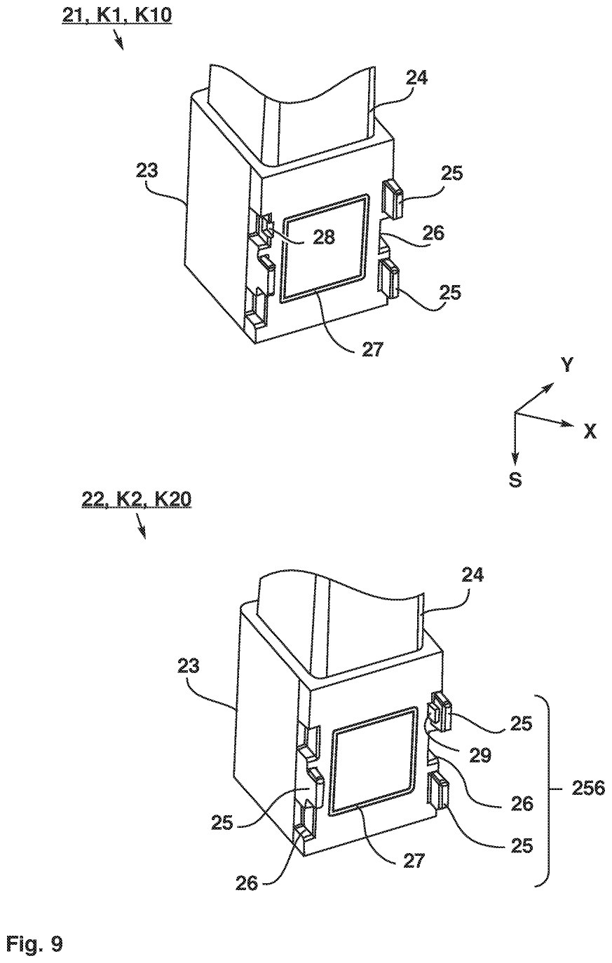

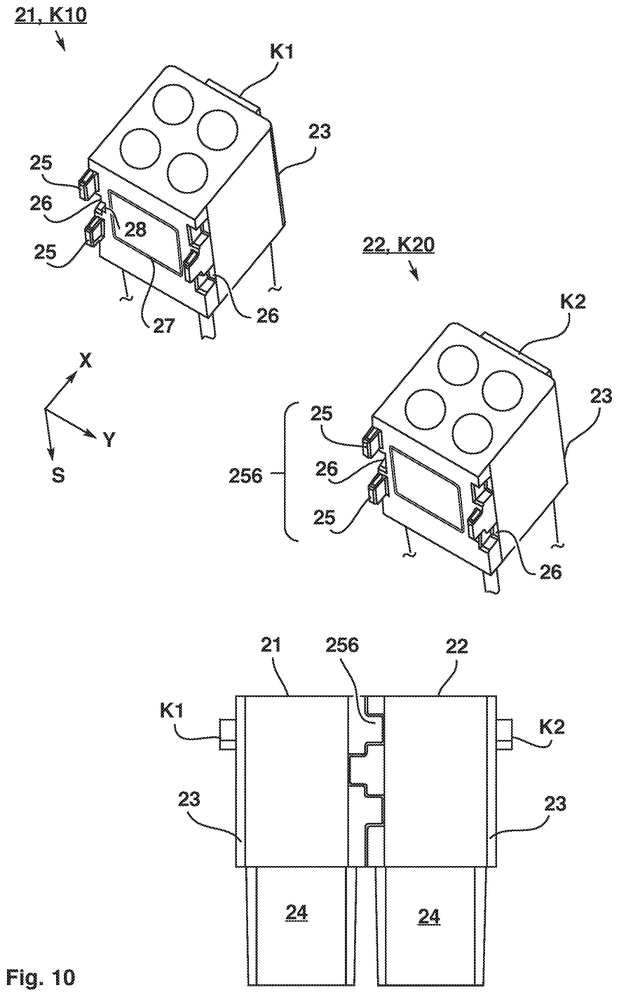

FIGS. 9 and 10 show in a perspective illustration two further module elements 21 and 22. The module elements 21 and 22 correspond, with their retaining contours 256 which are provided at edges, extending in the plug-in direction S, of a wall of the module elements 21 and 22, substantially to the configuration of FIGS. 5 and 7, for which reason in this regard reference is made here to the above description.

Unlike in the configurations of FIGS. 5 and 7, the third coding K10 of the first module element 21 of the configuration of FIGS. 9 and 10 has a recess 28 which is designed as a depression of a pocket 26 in the second direction Y. A projection 29 corresponding in form-fitting fashion to this recess 28 is designed accordingly in the second direction Y at a tab 25, corresponding with the pocket 26, of the second module element 22 and supplies the fourth coding 20.

The codings K10 and K20 are likewise designed so that they correspond with each other in such a way that, in the case of an assembled first 21 and second 22 module element, the projection 29 is arranged in the recess 28 and an assembled plug-in connector module 2 is supplied, whilst a first module element 21 cannot be assembled with a further first module element 21, and a second module element 22 cannot be assembled with a further second module element 22. Illustrated in the drawings is a plug-in connector module 2 assembled from a first 21 and second 22 module element.

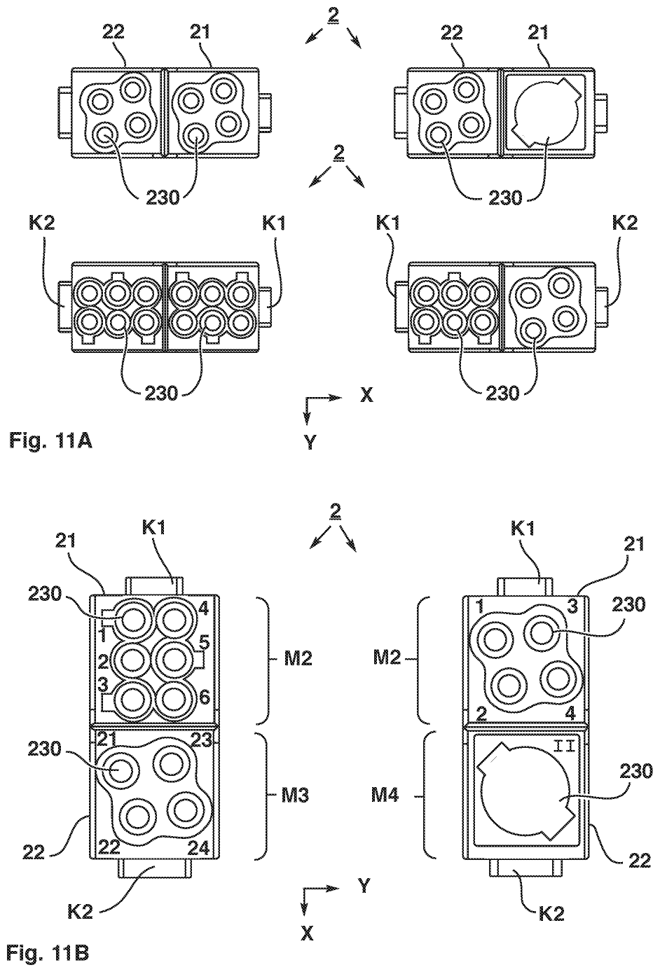

FIG. 11A shows examples of plug-in connector modules 2 assembled from module elements 21 and 22 and FIG. 11B shows two plug-in connector modules 2 of FIG. 11A in an enlarged illustration.

The first 21 and second 22 module elements can each have a different number of contact inserts 230 for contact means and be suitably designed for receiving pin-like or socket-like contact means. The contact inserts 230 are particularly advantageously each identified with labels of markings M2, M3, M4, and M5 which in each case clearly label a contact insert 230 of the module elements 21 and 22 and which here moreover label the contact inserts 230 in each case as a contact insert 230 of a first 21 or second 22 module element.

The labels of the marking M2, namely 1, 2, 3, 4, 6, etc, identify in a suitable fashion in each case a contact insert 230 of a first module element 21. The labels of the marking M3, namely 21, 22, 23, 24, etc, identify in a suitable fashion in each case a contact insert 230 of a second module element 22. The label of the marking M4, namely II, identifies in a suitable fashion a contact insert 230 of a second module element 22 which has further contact inserts. A label, not illustrated in the drawings, of the marking M5, namely I, identifies in a suitable fashion a contact insert 230 of a first module element 21 which has further contact inserts.

The abovementioned clear identification with the labels of the marking M2, M3, M4, and M5 allows particularly simple assembly of a plug-in connector module 2 from a first 21 and second 22 module element, as well as particularly simple and correct placement of contact means at the contact inserts 230 of the module elements 21 and 22, and furthermore, together with the abovementioned markings M1 of a retaining frame 1, namely A, B, C, D, E, and F or a, b, c, d, e, and f, particularly simple and correct placement of the plug-in connector module 2 at the retaining frame 1.

By means of a large number of first module elements 21, which can in each case have contact inserts 230 for pin-like and socket-like contact means, and by means of a large number of second module elements 22, which likewise can in each case have contact inserts 230 for pin-like and socket-like contact means, wherein the module elements 21 and 22 are provided in each case with the abovementioned advantageous clear labels of the markings M2, M3, M4, and M5, a construction kit is supplied for assembling a large number of different predetermined plug-in connector modules 2 and for placement of contact means at the plug-in connector modules 2. Furthermore, by means of the large number of first 21 and second 22 module elements, a construction kit is supplied for placement of a large number of different plug-in connector modules 2 at a retaining frame 1.

Together with a large number of retaining frames 1 having in each case a marking M1, a construction kit for assembling and fitting a plug-in connector is advantageously furthermore supplied by means of the abovementioned construction kit.

The module elements 21 and 22 described above with reference to the drawings can be produced from a suitable plastic and in particular from fiberglass-reinforced polycarbonate by means of injection molding. The module elements 21 and 22 of an assembled plug-in connector module 2 can additionally be, for example, adhesively bonded to each other or be connected to each other by means of ultrasonic or laser welding.

Modified configurations of the module elements 21 and 22 with correspondingly modified tabs 25 can be supplied from metal or ceramic, wherein the module elements 21 and 22 of an assembled plug-in connector module 2 are held in the direction Y and plug-in direction S so that they cannot be displaced, tilt, and twist and are held against each other in the direction X so that they cannot tilt and twist. After insertion of the plug-in connector module 2 into a retaining frame 1, the module elements 21 and 22 are held against each other by the retaining frame 1 in the direction X additionally so that they cannot be displaced.

The module elements are designed in the region of their first and second wall of their cable connection region 23 in such a way that the plug-in connector module 2 assembled from the module elements 21 and 22 can have in each case a length of 1 to 4 cm in the first X and second Y direction. The length of a module element 21 and 22 in the first direction X is here preferably in each case approximately 1.5 cm and in the second direction Y in each case approximately 1.6 cm. The tabs 25 and pockets 26 here in a suitable fashion in the plug-in direction S in each case have a length L of approximately 3 mm and also extend by approximately 2 mm in the direction X. The width, extending in the direction Y, of the tabs 25 and pockets 26 is advantageously approximately 1 mm.

Even if different aspects or features of the invention are shown in each case in combination in the figures, it is clear to a person skilled in the art, unless stated otherwise, that the illustrated and discussed combinations are not the only possible ones. In particular, mutually corresponding units or combinations of features from different exemplary embodiments can be exchanged with one another.

### LIST OF REFERENCE SIGNS

1 retaining frame
10 wall
2 module
21 module element
22 module element
23 cable connection region
230 contact insert
24 plug-in region
25 tab
250 rib
251 bevel, rounded edge, chamfered edge
256 retaining contour
26 pocket
261 bevel, rounded edge, chamfered edge
27 groove
270 depression, depressed surface
28 recess, step
projection, stud
A application point
L length
N level
P plug-in location
X, Y, S direction
K1, K2, K10, K20 coding, width
M1, M2, M3, M4, M5 marking

1.-16. (canceled)

17. An assembly, comprising:
a retaining frame (1); and
a plug-in connector module (2) arranged at a plug-in location (P) within the retaining frame (1),
wherein the plug-in connector module (2) includes a module coding (K1, K2) that allows the plug-in connector module (2) to only be inserted into the plug-in location (P) in a predetermined orientation,
wherein the plug-in connector module (2) includes
a first module element (21) and
a second module element (22) that is not identical to the first module element (21),
the first module element (21) and the second module element (22) being connected to each other,
wherein the first module element (21) and the second module element (22) each include an element coding (K10, K20) that allows only matching module elements (21, 22) to be connected to each other;
wherein the first module element (21) includes a first coding (K1) of the module coding, and
wherein the second module element (22) includes a second coding (K2) of the module coding.

18. The assembly as in claim 17,
wherein the module coding (K1, K2) and the element coding (K10, K20) are coordinated, whereby only suitable module elements (21, 22) can be arranged in the plug-in location (P).

19. The assembly as in claim 17,
wherein the element coding (K10, K20) includes
a third coding (K10) with a tab (25) formed on the first module element (21), and
a fourth coding (K20) with a pocket (26) formed on the second module element (22), and
wherein the tab (25) engages the pocket (26) when the first module element (21) is connected to the second module element (22).

20. The assembly as in claim 19,
wherein a positioning of the tab (25) prevents the first module element (21) to be connected to another first module element (21).

21. The assembly as in claim 19,
wherein the first coding (K1) is arranged on a first wall of the first module element (21), and
wherein the third coding (K10) is arranged at an edge of a second wall of the first module element (21) situated opposite the first wall of the first module element (21), and
wherein the second coding (K2) is arranged on a first wall of the second module element (22), and
wherein the fourth coding (K20) is arranged at an edge of a second wall of the second module element (22) situated opposite the first wall of the second module element (22); and
wherein the first module element (21) has a first retaining contour (256) at its second wall which interacts with a second retaining contour (256) on the second wall of the second module element (22) in such a way that the first module element (21) and second module element (22) form the plug-in connector module (2) with the first coding (K1) and the second coding (K2).

22. The assembly as in claim 21,
wherein the first retaining contour (256) is formed at an edge of the second wall of the first module element (21) and
wherein the second retaining contour (256) is formed at an edge of the second wall of the second module element (22).

23. The assembly as in claim 21,
wherein the first retaining contour (256) and the second retaining contour (256) (256) include
tabs (25) extending in a first direction (X) and in a plug-in direction(S) and
pockets (26), designed to correspond with the tabs (25),
the tabs (25) and the pockets (26) being alternately arranged above one another in a row, and
wherein the first retaining contour (256) and the second retaining contour (256) engage inside each other in such a way that the second wall of the first module element (21) and the second wall of the second module element (22) are arranged adjacently to each other and touch each other,
wherein the tabs (25) of the first module element (21) and second module element (22) engage corresponding ones of the pockets (26) of the second module element (22) and the first module element (21) in a form-fitting fashion such that the first module element (21) and second module element (22) are held against each other in the first direction (X), a second direction (Y), and the plug-in direction(S) so that they cannot twist and tilt and are held in the second direction (Y) and the plug-in direction(S) so that they cannot be displaced relative to one another.

24. The assembly as in claim 23,
wherein the tabs (25) have a predetermined oversize compared with the pockets (26) such that the tabs (25) are inserted in a form-and force-fitting fashion into the pockets (26), and
wherein the tabs (25) are plastically deformed when inserted into the pockets (26).

25. The assembly as in claim 24,
wherein the tabs (25) have at least one rib (250) which widens the tabs (25) in and/or counter to the plug-in direction(S) and extends in the first direction (X), and
wherein the tabs (25) have tab bevels (251), in form of chamfered or rounded edges at their rim extending in the plug-in direction(S), and
wherein the pockets (26) have pocket bevels (261), in form of chamfered or rounded edges at their rim, which interact with the tab bevels (251).

26. The assembly as in claim 21,
wherein the second wall of the first module element (21) or the second wall of the second module element (22) includes
a depression (270) provided in a central region of the second wall and
a groove (27) which surrounds the depression (270).

27. The assembly as in claim 17,
wherein in each case two tabs (25) and pockets (26) are arranged in a plug-in direction(S) above and below an application point (A) of the plug-in connector module (2) on a level (N) with the first coding (K1) and the second coding (K2) of the plug-in connector module (2) such that torques initiated by plug-in and pulling forces and acting on a separation point of the first module element (21) and the second module element (22) are canceled out.

28. The assembly as in claim 21,
wherein the third coding (K10) is integrated into the first retaining contour (256), and
wherein the fourth coding (K20) is integrated into the second retaining contour.

29. The assembly as in claim 21,
wherein the third coding (K10) and the fourth coding (K20) extend along opposite edges of the second wall of the first module element (21) and the second wall of the second module element (22).

30. The assembly as in claim 17,
wherein the first module element (21) includes a predetermined first number of contact inserts (230) for receiving pin contacts or a predetermined second number of contact inserts (230) for receiving socket contacts, and
wherein the second module element (22) includes a predetermined third number of contact inserts (230) for receiving pin contacts or a predetermined fourth number of contact inserts (230) for receiving socket contacts.
